(19) United States
(12) Patent Application Publication
(10) Pub. No.: US 2019/0214838 A1
(43) Pub. Date: Jul. 11, 2019

(54) MINIATURE POWER CHARGER FOR ELECTRICAL DEVICES

(71) Applicant: Thin Energy Ltd., Lod (IL)

(72) Inventor: Ilya NEMENMAN, Modi'in-Maccabim-Re'ut (IL)

(73) Assignee: Thin Energy Ltd., Lod (IL)

(21) Appl. No.: 16/326,225

(22) PCT Filed: Jun. 15, 2017
(86) PCT No.: PCT/IL2017/050665

§ 371 Date: Feb. 18, 2019

(30) Foreign Application Priority Data
Aug. 18, 2016 (IL) 247353

(51) Int. Cl. H02J 7/02; H02M 7/217; H02M 1/44

(52) U.S. Cl. CPC H02J 7/022; H02M 2001/007; H02M 1/44; H02M 7/217

(57) ABSTRACT

A miniature electrical power charger for an electrical device comprises a rectifier for converting non-isolated AC electrical grid with first voltage level to non-isolated DC voltage with second voltage level, a DC-DC voltage converter for converting the non-isolated DC voltage with second voltage level to non-isolated intermediate DC voltage of a third voltage level and a transformer unit for converting the non-isolated intermediate DC voltage of a third voltage level to an isolated low DC voltage of a fourth voltage level.

### BACKGROUND OF THE INVENTION

The present invention relates to the field of electric power chargers. More particularly, the present invention relates to a miniature sized electrical device power charger.

One aspect of technology progress is the miniaturization of electrical devices and their accessories. For instance, the computation capability of a modern mobile phone would have required a very large device only a few years ago, compared to the modern hand-held size. The user of a modern device is capable of performing technologically complex operations and computations using a small hand-held device, such as GPS navigation, web surfing, video content viewing and recording, etc.

In the field of electrical device chargers, regulation and safety restrictions require that an electrical device be electrically isolated from an AC electrical grid. The isolation is most commonly used to protect against electric shock while connected to an AC electrical grid. The most common electrical component capable of conducting electrical current while isolating the supplied circuit from the AC electrical grid is an isolation transformer. The principle which allows a transformer to supply isolated power is Galvanic Isolation, which performs power exchange between two sections of an electric circuit, while preventing current flow and conduction between them.

Typical transformers consist of a core and a plurality of windings. The number of windings and the properties of the core, including its size, are derived from the inductance and the required ratio between the power levels on each side of the transformer. These two components, i.e. windings and core, are which determine the physical size of a transformer.

In the case of electrical device power chargers, transformers play a key role. Because an isolation transformer is required in order to isolate a device from the AC electrical grid, a charger containing such a transformer cannot be physically smaller than the size of the windings and core comprising the transformer.

It is therefore an object of the present invention to provide a method for minimizing the size of electrical device power chargers, while following the isolation safety restrictions.

It is yet another object of the present invention to provide a small electrical device charger according to the above method. Other objects and advantages of the invention will become apparent as the description proceeds.

### SUMMARY OF THE INVENTION

A miniature electrical power charger for an electrical device is disclosed comprising a rectifier for converting non-isolated AC electrical grid with first voltage level to non-isolated DC voltage with second voltage level, a DC-DC voltage converter for converting said non-isolated DC voltage with second voltage level to non-isolated intermediate DC voltage of a third voltage level and a transformer unit for converting said non-isolated intermediate DC voltage of a third voltage level to an isolated low DC voltage of a fourth voltage level wherein the electrical power charger is comprised in a spatial volume having a thickness of less than 4 mm capable of providing 10 W at 5 VDC output, and, for example, length of less than 85 mm and width of less than 54 mm.

According to some embodiments the charger further comprising a filter for filtering high DC voltage and providing clean high DC voltage to the voltage converter.

According to some embodiments the high supplied AC voltage is in the range of 220-240 VRMS.

According to some embodiments the high supplied AC voltage is in the range of 90-127 VRMS.

According to some embodiments the low isolated DC voltage is lower than 30V.

According to some embodiments the intermediate DC voltage is in the range of 50-100V.

According to some embodiments the DC-DC voltage converter is one of a buck converter, a boost converter or a buck-boost converter.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a block diagram describing the operation of a miniature power charger, according to an embodiment of the present invention;

FIG. 2 shows a flowchart of the voltage conversion and supply according to an embodiment of the invention.

FIGS. 3a, 3b, 3c, 3d and 3e each illustrate a method of converting high DC voltage to intermediate DC voltage.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention is directed towards a miniature power charger for electrical devices. Specifically, it is directed towards a miniature charger with thickness of less than 4 mm, and, for example, length of less than 85 mm and width of less than 54 mm. The primary size factor containment of such chargers is the electrical transformer included within them, which typically limits reduction in the thickness dimension. A transformer is required primarily in order to meet the safety requirement of galvanic isolating an electrical device from the AC electrical grid. A transformer is also required in order to transfer high voltage, i.e. 90-230V, to low operation voltage, i.e. 5-30V, while keeping the safety isolation requirement. The power transfer requirement of the transformer, which is determined by the power designed to be provided to the electrical device, along with the required inductance of the transformer, determine the number of windings and the core magnetic features of the transformer. These two features, i.e. the number of windings and core magnetic features, impose minimal physical dimensions on the transformer, and therefore on a charger containing such a transformer, in order to enable transfer of the required power, while complying with the safety requirements.

The present invention introduces a power charger solely comprising miniature components, while maintaining safety requirements, and electrically efficient power transformation. The charger utilizes an intermediate voltage level between the high network voltage level and the low operation voltage level that is fed to the primary side of the transformer, which allows the reduction of transformer size, is explained in details herein below. A first stage of the charger, which is designed and operative according to embodiments of the present invention, is used in order to safely convert high voltage of an AC electrical grid to an intermediate, non-isolated voltage level, and a second stage of the charger converts the intermediate voltage to low and isolated voltage adapted to the voltage at which a connected electrical device operates or charges.

The utilization of an intermediate voltage level allows the isolation to occur only at one of the voltage levels transitions, therefore allowing a portion of voltage level transition to be non-isolated, as long as the voltage at the output of the charger is isolated from the voltage at the input of the charger, e.g. grid voltage. Because the first stage of the electrical circuitry of the charger is not required to comply with voltage isolation requirements, miniature components, such as inductors and/or capacitors, can be used in the electrical circuitry of the first stage, while electrical components that comply with high working voltage and need to comply with electrical isolation requirements are typically large components, such as components used in common power supply circuits, such as transformers, for example for voltage level transition.

The use of intermediate voltage level for feeding the primary stage of the transformer introduces an additional advantage which allows transformer size reduction; inasmuch the circuit's switching frequency is isolated from the electrical grid and therefore may be set to any desired frequency higher than that of the grid. Because the frequency of the voltage feeding the transformer is inversely proportional to the required inductance figure, use of high switching frequency in the first stage of the charger circuitry, where no transformer is used, as described herein, separates the frequency of the voltage fed to the transformer from the grid frequency thereby enables inductance reduction compared to circuits operating in lower frequencies.

Although the final voltage transition from an intermediate and non-isolated voltage level to a low level-isolated-voltage requires a transformer, the physical size of the transformer in this location in the circuit topology according to embodiments of the present invention can now be smaller than the physical size of a transformer used in a charger circuit where it is used to apply voltage transition from high level to low level. This advantage is enabled due to the voltage transition of the transformer now being from an intermediate level to a low level which requires less inductance, and therefore less transformer windings and a smaller transformer core, and thereby smaller transformer volume. A known designing rule for transformers dictates:

$${A}_{i} = \frac{1}{4.44 {fB}_{m} {T}_{e}} \qquad ( 1 )$$

### Where:

Ai is the transformer's magnetic core cross section area
f is the transformer's operating frequency
Bₘ is the magnetic flux
Tₑ is the turn-per-volts figure
   As may be seen from this formula the higher is the operating frequency the lower may be the cross section of the transformer's magnetic core, thereby enabling reduction of the physical dimension of the transformer.

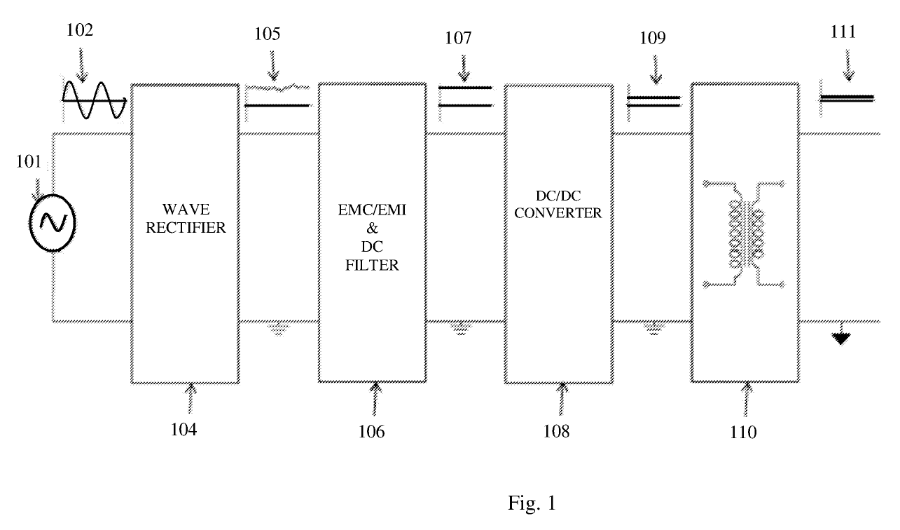

FIG. 1 illustrates a block diagram describing the main structural elements and representative waveforms of a miniature power charger, according to an embodiment of the present invention. AC electrical grid 101 generates a sine wave 102, which is of high amplitude (90 VRMS-230 VRMS) and non-isolated or non-floating, i.e. including neutral termination. Sine wave 102 enters a wave rectifier 104, which includes blocks capable of converting the AC wave 102 to a DC wave 105 of similar magnitude. At wave rectifier 104 the conversion is performed without applying isolation to the wave. The non-isolated DC wave 105 enters an electromagnetic compatibility/electromagnetic interference (EMC/EMI) and DC filter 106, for filtering out signal disturbances, resulting in a clean DC high and non-isolated voltage 107. The clean high voltage 107 enters a DC-DC converter 108, which converts the signal to an intermediate voltage DC level signal 109, still non-isolated. Once the voltage is in the intermediate state, it can be converted to the target isolated low voltage. This is achieved by block 110, which typically comprises a transformer for achieving both a voltage step down and isolation. The result is a low level isolated voltage 111, in the required voltage level, typically ranging from 5 VDC to 20 VDC.

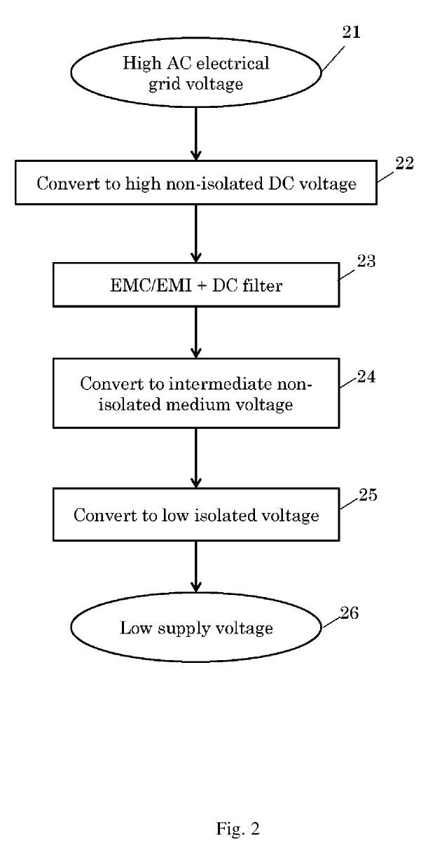

FIG. 2 shows a flowchart of the transitions applied to the voltage from entrance to a charger according to an embodiment of the invention. In step 21, AC electric grid voltage, typically 90 VRMS to 230 VRMS is supplied to the charger circuit. At step 22, the high voltage is converted, i.e. rectified, to non-isolated high DC voltage. At step 23, the non-isolated high DC voltage enters an EMC/EMI and DC filter for filtering out disturbances. The outcome of this step is a clean non-isolated high DC voltage, which in step 24 is fed to a DC voltage converter for converting the high DC voltage to a non-isolated intermediate DC voltage. In step 25 the non-isolated intermediate DC voltage is converted to the target low isolated DC voltage. Once this voltage level has been reached, and the isolation safety requirements have been met, the low isolated DC voltage may be supplied to the target device in step 26, thus completing the voltage transitions and handling steps of the power supplier.

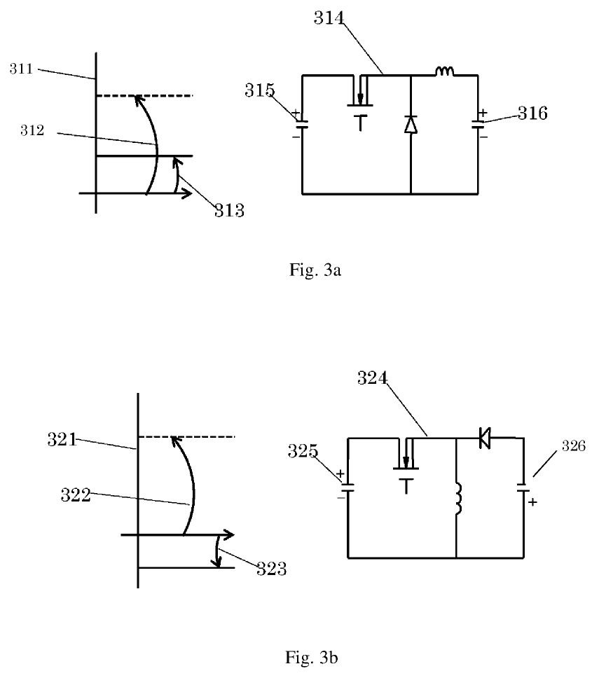

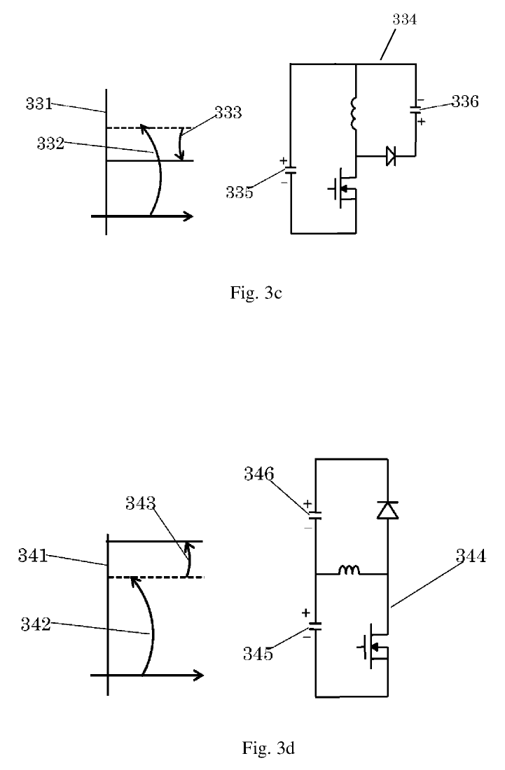

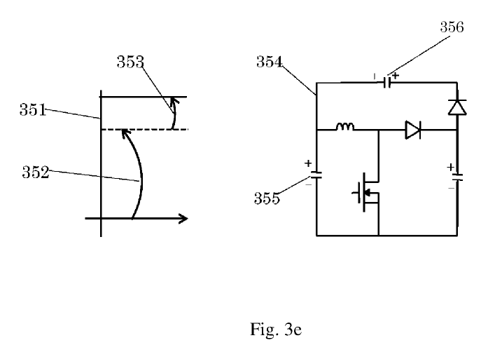

FIGS. 3a, 3b, 3c, 3d and 3e illustrate five variations of DC-DC converters and the voltages associated thereof. The conversion from high DC voltage to intermediate DC voltage, according to the present invention, can be performed by, but is not limited to, one of the DC-DC converters illustrated in FIGS. 3a-3e and according to their associated voltages.

FIG. 3a shows a graphic example 311 of a relation between a high voltage 312 and an intermediate voltage 313. Circuit 314 is an electronic circuit which can be used to obtain such a relation, wherein capacitor 315 is used to store the high voltage and capacitor 316 is used to store the intermediate voltage.

Similarly, FIGS. 3b-3e show other graphic examples, 321, 331, 341 and 351, respectively, presenting relations between high voltages (322, 332, 342, and 352, respectively) and intermediate voltages (323, 333, 343, and 353 respectively). Circuits 324, 334, 344 and 354 are electronic circuits which can be used, respectively, to obtain such voltage relations, wherein capacitors 325, 335, 345 and 355 respectively are used to store the high voltage, and capacitors 326, 336, 346 and 356 respectively are used to store the intermediate voltage.

The converter type of FIG. 3a, i.e. converter 314, is topologically defined as a buck converter. The converter types of FIGS. 3b, 3c and 3d, i.e. converters 324, 334 and 344, are topologically defined as buck-boost converters. The converter of FIG. 3e, i.e. converter 354, is topologically defined as a boost converter.

Conversion of intermediate voltage to low voltage requires less windings and a smaller core and allows a higher switching frequency than the conversion of high AC voltage to low DC voltage. Consequently, the utilization of an intermediate voltage rate enables the minimization of the major size factor of electrical device power chargers, while maintaining isolation safety instructions.

In order to achieve very limited physical dimensions of the charger, according to embodiments of the present invention, careful compromise should be done between plurality of restricting variables, which tend to contradict with each other. For example, keeping the thickness of the charger below 4 mm for a charger of 10 W dictates use of even a thinner transformer which, in turn, in order to enable transforming of sufficient electrical energy needs to extend its length and width dimensions. Another example is the constrain imposed by a very thin transformer on the transformer windings, leaving very little room for them, and the electrical inrush isolation requirements that dictates use of isolated wires, imposes even higher limitation on the room available for the windings. For example, the high inrush voltage isolation requirement may be 3000 VAC or 4242 VDC. A charger designed according to embodiments of the present invention may have a in/out voltage level ratio in a buck topology of 230V:46V, which is 5:1 ratio, and in flyback topology of the isolated stage voltage ratio of 46V:5V, which is a 8:1 ratio. The second stage voltage ration may be determined using the following considerations.

$$\frac{{V}_{out}}{{V}_{in}} = \frac{\frac{{N}_{2}}{{N}_{1}} * D}{1 - D} \qquad ( 2 )$$

Where:
N1 is the primary windings number
N2 is the secondary windings number
D is duty cycle

The frequency selected for the transformer, for transiting the power through the transformer, may be determined according to one or more of plurality of considerations and variables such as the required inductance of the transformer, the physical dimension's limitations, the transformer core material, power capability of the transformer, etc.

In order for a charger structured and operative according to embodiments of the present invention to comply with the USA and EU requirements of minimal efficiency, it should have an overall efficiency of:

US_{Eff}≥0.0834*ln(P_{OUT})−0.0014*P_{OUT}+0.609;NoLoad power≤100 mW

EUeff≥0.0834*ln(P_{OUT})−0.0011*P_{OUT}+0.609;NoLoad power≤75 mW

Considering the above mentioned constrains and limitations yields, for a very thin charger according to embodiments of the present invention, and specifically the thickness limitation of less than 4 mm for a 10 W, 240 VAC input charger, that the intermediate voltage will be selected in the range of 40-70V in order to enable reduction of the physical dimension of the transformer, and availability of capacitors with high enough capacitance and with small enough physical dimensions, for example two (or more) capacitors of 100 uF/25V in parallel for a capacitor compatible for 46V.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An electrical power charger for an electrical device, comprising:
a rectifier for converting non-isolated AC electrical grid with first voltage level to non-isolated DC voltage with second voltage level;
a DC-DC voltage converter for converting said non-isolated DC voltage with second voltage level to non-isolated intermediate DC voltage of a third voltage level; and
a transformer unit for converting said non-isolated intermediate DC voltage of a third voltage level to an isolated low DC voltage of a fourth voltage level,
wherein the electrical power charger is comprised in a spatial volume having a thickness of less than 4 mm, and capable of providing at least 10 W at 5 VDC output.

2. The charger of claim 1, further comprising a filter for filtering high DC voltage and providing clean high DC voltage to the voltage converter.

3. The charger of claim 1, wherein the high supplied AC voltage is in the range of 220-240 VRMS.

4. The charger of claim 1, wherein the high supplied AC voltage is in the range of 90-127 VRMS.

5. The charger of claim 1, wherein said low isolated DC voltage is lower than 30V.

6. The charger of claim 1, wherein the intermediate DC voltage is in the range of 50-100V.

7. The charger of claim 1, wherein the DC-DC voltage converter is one of a buck converter, a boost converter or a buck-boost converter.
